(19) United States
(12) Patent Application Publication
(10) Pub. No.: US 2026/0365109 A1
(43) Pub. Date: Nov. 19, 2026

(54) SYSTEM AND METHOD FOR VEHICLE COCKPIT DISPLAY AND ELECTRONIC SIDE MIRROR

(71) Applicant: TOYOTA JIDOSHA KABUSHIKI KAISHA, Toyota-shi (JP)

(72) Inventor: Takahiro NAGAKARI, Tokyo (JP)

(73) Assignee: TOYOTA JIDOSHA KABUSHIKI KAISHA, Toyota-shi (JP)

(21) Appl. No.: 19/207,614

(22) Filed: May 14, 2025

(51) Int. Cl. B60R 1/26; B60K 35/23; B60K 35/26; B60K 35/28; G06F 3/14

(52) U.S. Cl. CPC B60R 1/26; B60K 35/23; B60K 35/26; B60K 35/28; G06F 3/1446; B60K 2360/178; B60K 2360/1868; B60K 2360/1876; B60R 2300/8026

(57) ABSTRACT

A heads-up display (HUD) for displaying information for a vehicle may be provided, the HUD including a central partition; and at least one peripheral partition, wherein the heads-up display is configured to: determine a change in vehicle status has occurred; and based on determining the change in vehicle status has occurred, configuring the at least one peripheral partition to display a video feed from at least one electronic side mirror of the vehicle.

Example embodiments of the present disclosure relate to heads up displays (HUD) for vehicles with electronic side mirrors.

### BACKGROUND

In the related art, an electronic control unit (ECU) of a vehicle may have firmware or parameters configured therein for controlling a vehicle. To this end, an engineer or mechanic may intend to tune specific values, for example, parameters related to throttle control, by performing calibration on said ECU. For example, a user may send an encoded message to the ECU (e.g., in view of payload limitations, etc.), and the ECU may follow a procedure in order to decode the message to perform the calibration.

In the related art, vehicles may implement electronic side mirrors over traditional side mirrors in order to provide a better viewing angle at the side of the vehicle for the vehicle operator to make decisions while driving. In particular, blindspots which are present in traditional side mirrors can be seen using the electronic side mirrors.

In addition, heads-up displays which may be mounted close to the steering wheel may be introduced, in order for the user to have more readily available access to vehicle-related information.

The electronic side mirrors are usually placed on the far sides of the vehicle (to the left or the right), accordingly, the vehicle operator may have a very long eye movement distance for the electronic side mirror which is on the opposite side of the steering wheel.

In the case of the electronic side mirror which is on the same side of the steering wheel, other peripherals and steering wheel heads-up display (which may interchangeably be referred to as a “vehicle cockpit” herein) may cause visual obstruction, further hindering the user's ability to view the content of the electronic side mirror.

This may be detrimental for the operation of the vehicle in situations where the vehicle operator needs to make quick decisions based on the electronic side mirrors. Accordingly, there is a need for a collaboration between the heads-up display and the electronic side mirrors to provide improved user accessibility and reduce visual obscuration.

### SUMMARY

Example embodiments consistent with the present disclosure provide a heads-up display (HUD) for displaying information for a vehicle, the HUD including a central partition; and at least one peripheral partition, wherein the heads-up display is configured to: determine a change in vehicle status has occurred; and based on determining the change in vehicle status has occurred, configuring the at least one peripheral partition to display a video feed from at least one electronic side mirror of the vehicle.

Based on the above, the electronic side mirror video feed will be automatically shown in the peripheral display of the heads-up display based on a change in vehicle status, and accordingly, the vehicle operator can seamlessly view the content of the electronic side mirrors, only when it is necessary. Furthermore, it will be within the vehicle operator's field of view such that there will not be any fatigue from long-distance eye movements.

According to example embodiments, determining the change in vehicle status has occurred may be based on receiving a signal from an Electronic Control Unit (ECU) of the vehicle. The change in vehicle status may include at least one of a turn light of the vehicle being switched; a gear position of the vehicle being switched into reverse; and another vehicle being detected in the blind spot of the vehicle.

The at least one peripheral partition may be configured to display the video feed from the at least one electronic side mirror by including a visual or audio cue. The central partition may include an instrument cluster, wherein the instrument cluster includes a configuration interface for a user to control the video output of displays in the vehicle, including the at least one peripheral partition. The instrument cluster may include a warning message overview interface for indicating which of the displays in the vehicle have a warning message, wherein the user may interact with the warning message overview interface to show details of the warning message. The warning message may include a priority level including at least one of high priority, medium priority, and low priority, wherein the warning message overview interface is configured to indicate each warning message of a given priority level with a unique color.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example arrangement of a HUD interface in a vehicle according to one or more example embodiments;

FIG. 2 illustrates an example screen view of an instrument cluster (IC) display, according to one or more example embodiments;

FIG. 3 illustrates an example warning view of an instrument cluster (IC) display, according to one or more example embodiments;

FIG. 4 illustrates an example method for displaying a video feed on a peripheral partition of an HUD according to one or more example embodiments; and

FIG. 5 illustrates a diagram of an example components of a system that may be configured to implement one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to any suitable type of vehicle in which example embodiments of the present disclosure can be implemented. For instance, the “vehicle” may refer to a motorized vehicle such as a car, a truck, a bus, a motorcycle, or any other suitable type of automobile powered by an engine, motor, or other mechanical means. Alternatively or additionally, the “vehicle” described herein may refer to a bicycle, a skateboard, and any other suitable types of non-motorized vehicle, without departing from the scope of the present disclosure.

Example embodiments of the present disclosure provide a heads-up display (HUD) for displaying information for a vehicle may be provided, the HUD including a central partition; and at least one peripheral partition, wherein the heads-up display is configured to: determine a change in vehicle status has occurred; and based on determining the change in vehicle status has occurred, configuring the at least one peripheral partition to display a video feed from at least one electronic side mirror of the vehicle.

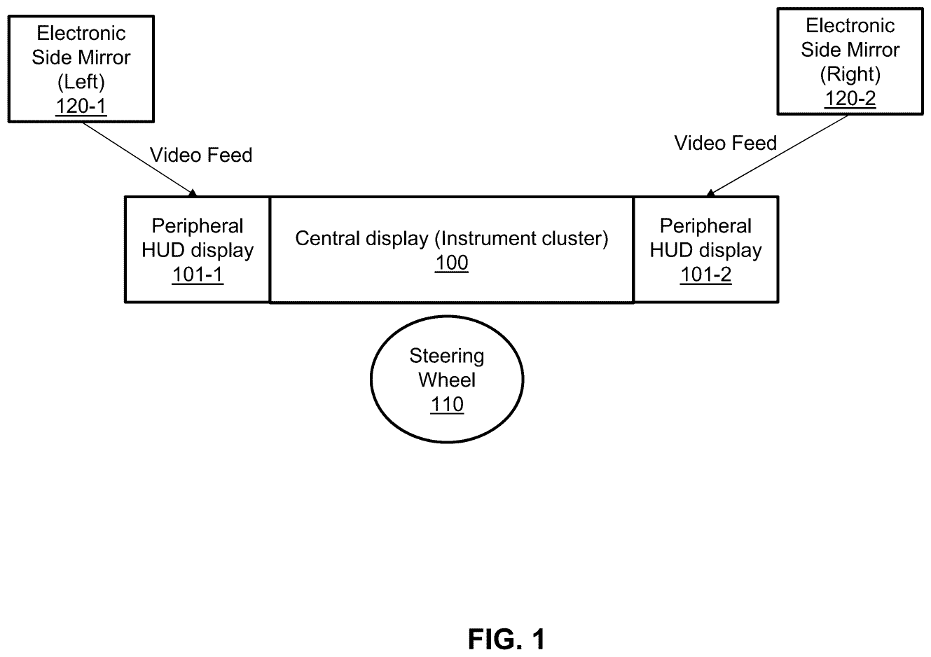

FIG. 1 illustrates a block diagram of an example arrangement of a HUD interface in a vehicle according to one or more example embodiments.

Two electronic side mirrors 120-1 and 120-2 may be provided, one corresponding to the left side, and another to the right side of the vehicle respectively. The HUD interface may comprise of a central display 100 (e.g., an instrument cluster (IC)), and at least one peripheral HUD display 101 (in the illustrated example, two peripheral displays 101-1 and 101-2 are surrounding the central display 100). According to embodiments, the elements of the HUD display may be interactable by the user (e.g., they may be implemented using a touchscreen, or they may respond via a gesture detected by the vehicle, voice activated, etc.). The HUD interface may be physically located above the steering wheel 110. It should be appreciated that the steering wheel 110 may be either closer to the left or right side, depending on the vehicle model.

As seen in FIG. 1, electronic side mirror 120-1 can project its video feed to peripheral HUD display 101-1, and likewise electronic side mirror 120-2 can project its video feed to peripheral HUD display 101-2. The peripheral HUD display 101 may only use a portion of its display to show the video feed, or it may be displayed using the entirety of its screen.

According to embodiments, the user (the driver or vehicle operator) may configure the peripheral HUD display 101-1 to show the electronic side mirror video feed or not. The configuration may be performed using a configuration interface either on the peripheral HUD display 101-1, or the central display 100. The peripheral HUD display 101-2 may automatically switch to display the video feed based on detecting a change in vehicle status. This change in vehicle status may be determined based on receiving, for example, a message from another electronic control unit (ECU) from the vehicle.

Examples of where the automatic switching of the display may occur may be based on the following conditions (not necessarily limited thereto): when the driver is switching the turn light (e.g., turning it on), when the configuration has been set in advance using the configuration interface, when another vehicle or object is detected in the blindspot of the vehicle (for example, using blind spot monitoring system, and receiving a message from that ECU), when the position of the gear is shifted (e.g., to reverse), etc. Other possible vehicle statuses may be included for the conditions, depending on the specific implementation.

According to embodiments, the peripheral HUD display 101 may be configured to have further audio or video cues in order to emphasize the video feed from the electronic side mirrors 120. This may include adding a highlighted border around the display, including a flashing border, having a beeping audio cue, an automated voice audio cue, etc. Other possible settings for displaying the video feed on peripheral HUD display 101 may be included.

Peripheral HUD display 101 may also be considered as “partitions” of the HUD interface. For example, the construction of the HUD could be using a singular display, but only portions of the display are partitioned for use as the central display 100 (partition) and one or more peripheral HUD displays (partitions). According to embodiments, each partition may also be its own individually constructed display. This may depend on the specific implementation of the HUD.

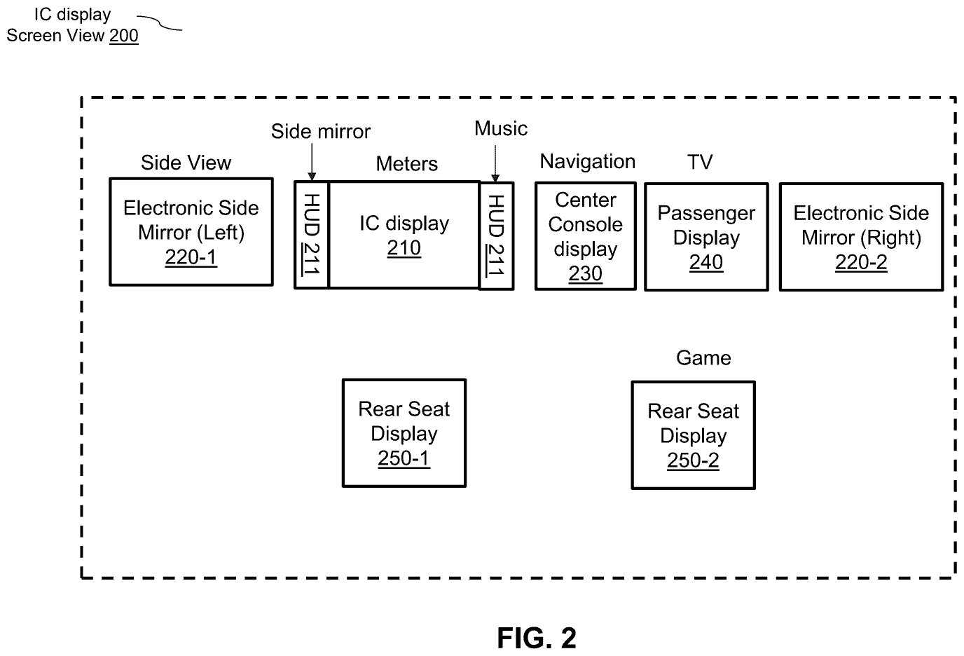

FIG. 2 illustrates an example screen view of an instrument cluster (IC) display 200, according to one or more example embodiments.

All the display screens which are in the vehicle may be shown in a summary overview on the central display 100/instrument cluster (IC), which details the content being displayed on each display screen of the vehicle. For example, IC display 210, HUD(s) 211, electronic side mirrors 220-1 and 220-2, central console display 230, passenger display 240, and rear seat displays 250-1 and 250-2 may be provided in the example shown in FIG. 2. It should be appreciated that the specific screens which are included may depend on the vehicle model and accordingly other arrangements or number of display screens shown in the example summary overview in FIG. 2 may vary depending on the specific implementation.

The user may interact (e.g., via touchscreen interface) to change what is shown on each display. For example, the HUD 211 (peripheral display 101) may show the electronic side mirror, whereas the main IC display 210 can usually show the meters (such as accelerometer, gas meter, etc.). Screen view 200 may, for example, indicate the content of what is being shown on each display screen as a text label, or it may provide a thumbnail preview of the content being shown.

In the example illustrated in FIG. 2, the right HUD 211 (the peripheral display 101) may show a music content, center console display 230 may show navigation guidance (e.g., GPS), passenger display 240 may show a TV, and one of the rear seat displays 250-2 may show a game.

It is contemplated that menus and/or options may be include for configuring the electronic side mirror displays in screen view 200 (not illustrated). Settings for the electronic side mirror display may also include configuring the audio and visual cues. According to some embodiments, this configuration may also be performed in HUD 211/peripheral display 101.

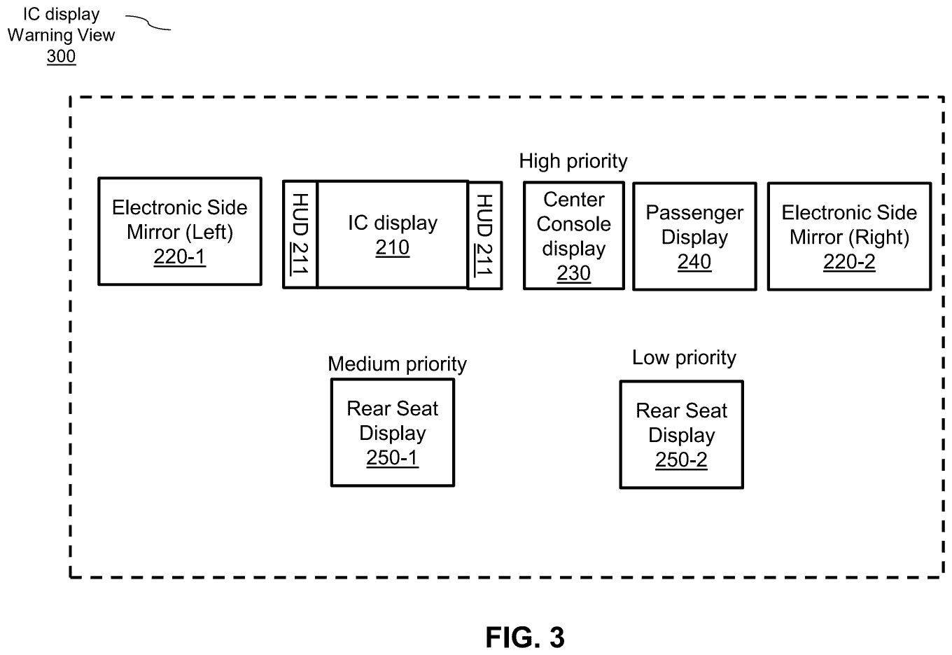

FIG. 3 illustrates an example warning view 300 of an instrument cluster (IC) display, according to one or more example embodiments.

Warning messages may have a priority level, (high priority, middle priority, low priority). For example, high priority may refer to a serious failure (e.g., engine related issues), medium priority may refer to a minor malfunction (e.g., air conditioning issue), and low priority may refer to a functional operation indication (e.g., TV cannot connect to satellite) According to embodiments, the instrument cluster may have a dedicated portion to only show which displays have a high priority warning message. The summary may show which displays are showing what priority level of warning messages using a unique color for each priority level. For example, high priority may be highlighted in red, middle priority may be highlighted in yellow, and low priority may be highlighted in green.

The user may interact with the warning messages by tapping on the touchscreen of the instrument cluster. This may expand the warning message into a dialogue box with a detailed description of the warning message. It may also include suggestions as to how to resolve the warning messages, depending on the issues.

In the example illustrated in FIG. 3, center console display 230 is currently indicating a high priority warning. This may be indicated, for example, as a text label, or with a colored highlighting (e.g., red). Rear seat display 250-1 may indicate a medium priority warning and may be highlighted for example in yellow. Rear seat display 250-2 may indicate a low priority warning and may be highlighted for example in green.

Warning view 300 may have a touchscreen button to switch the display setting with screen view 200. Nevertheless, it should also be appreciated that warning view 300 and screen view 200 may be combined into a single view in some implementations.

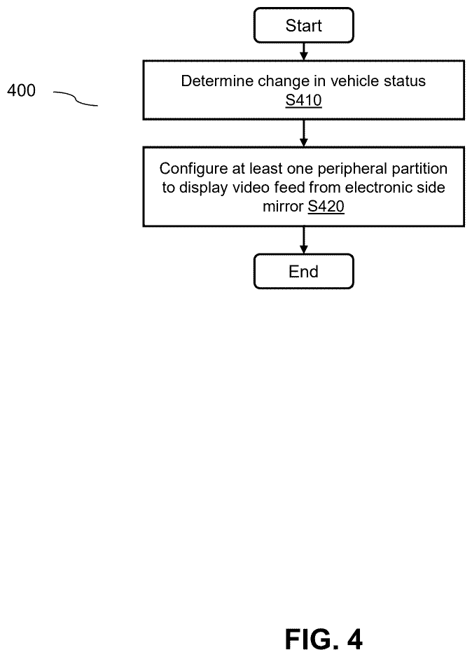

FIG. 4 illustrates an example method 400 for displaying a video feed on a peripheral partition of an HUD according to one or more example embodiments.

At operation S410, a change in a vehicle status may be determined. Determining the change in vehicle status may be based on receiving a signal from an Electronic Control Unit (ECU) of the vehicle. The change in vehicle status may include, for example, a turn light of the vehicle being switched, a gear position of the vehicle being switched into reverse, and another vehicle being detected in the blind spot of the vehicle.

At operation S420, based on detecting the change in vehicle status in operation S410, at least one peripheral partition may be configured to display a video feed from the electronic side mirror. The peripheral partition may also be configured to display the video feed from the at least one electronic side mirror by including a visual or an audio cue.

Example embodiments of the present disclosure can be understood based on the above, to allow the electronic side mirror video feed to automatically be shown in the peripheral display of the heads-up display based on a change in vehicle status, and accordingly, the vehicle operator can seamlessly view the content of the electronic side mirrors, only when it is necessary. Furthermore, it will be within the vehicle operator's field of view such that there will not be any fatigue from long-distance eye movements.

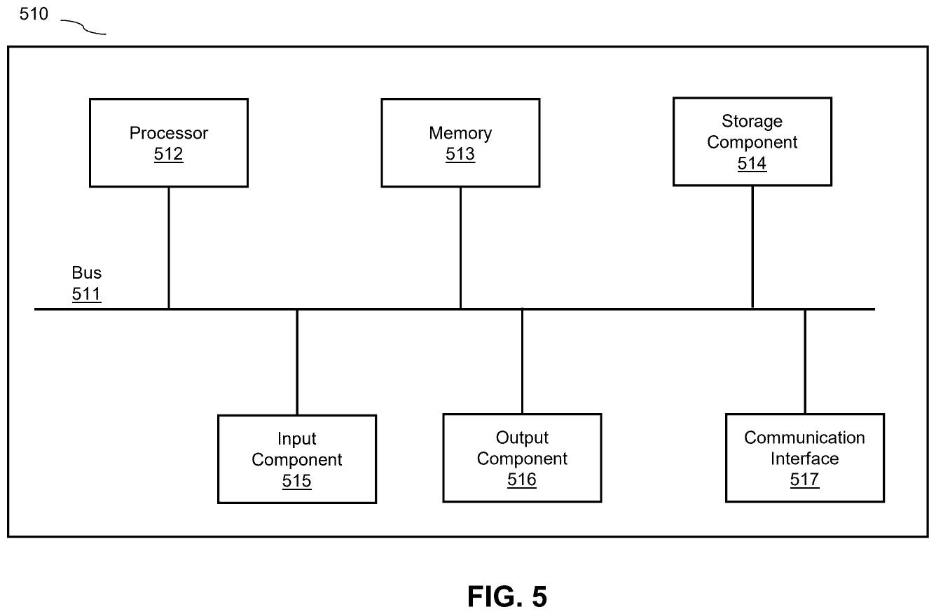

FIG. 5 illustrates a diagram of example components of a system, according to one or more example embodiments. As illustrated in FIG. 5, the system 510 may include at least one bus 511, at least one processor 512, at least one memory 513, at least one storage component 514, at least one input component 515, at least one output component 516, and at least one communication interface 517.

It is contemplated that the system 510 may include more or less components than illustrated in FIG. 5, without departing from the scope of the present disclosure. For instance, in some embodiments, the system 510 may include a plurality of storage components 514, the input component 515 and the output component 516 may be implemented as a transceiver component, the memory 513 and storage component 514 may be implemented as a memory storage, and the like.

The bus 511 may be configured to facilitate or enable communications among the components of the system 510. Specifically, the bus 511 may communicatively couple the components to each other and provide a means for data transfer and flow of control signals between the components. The bus 511 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 510 to enable communication and coordination between the components within the system 510 in real-time (or near real-time).

The processor 512 may be implemented in hardware, firmware, or a combination of hardware and software, and may be configured to handle real-time (or near real-time) data processing and control of the control system 510. The processor 512 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 510. In some implementations, the processor 512 may be capable of being programmed to perform one or more operations described herein. Further, the processor 512 may include a plurality of processing units, each of which is dedicated to performing a specific operation.

The memory 513 may include one or more mediums for storing temporary data, runtime variables, program instructions, and buffers required for the operations of the control system 510. The memory 513 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 510 to store information and/or instructions for use by the processor 512.

The storage component 514 may be configured to store non-volatile data, such as firmware, configuration settings, calibration data, information, and/or software related to the operation and use of the system 510. For example, the storage component 514 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage component 514 may be configured to store computer-readable or computer-executable instructions for implementing one or more operations of the system 510. The storage component 514 may provide the stored information to the memory 513 for the execution of the processor 512.

The input component 515 may include one or more input components that permit the system 510 to receive information, such as via user input (e.g., a touch screen display, a keyboard, a keypad, a mouse, a button, a switch, and/or a microphone). The output component 516 may include one or more output components that provide output information from the system 510 (e.g., a display, a speaker, a navigation device, one or more light-emitting diodes (LEDs), etc.) According to embodiments, the input component 515 and/or the output component 516 may be optional and may be excluded from the system 510.

The at least one communication interface 517 may include a transceiver-like component (e.g., a transceiver and/or a separate receiver and transmitter) that enables the system 510 to communicate with other components (e.g., ECUs, user devices, etc.), such as via a wired connection, a wireless connection, or a combination of wired and wireless connections. For example, communication interface 517 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 517 may include at least one input/output (I/O) interface, at least one network interface, at least one storage interface, or the like, that enable the components 512-516 to communicate with other components. Further, the communication interface 517 may include one or more application programming interfaces (APIs) that allow the system 510 (or one or more components included therein) to communicate with one or more software applications (e.g., software application deployed in the ECUs, etc.)

Computer-executable instructions (e.g., software instructions, etc.) may be read into memory 513 and/or storage component 514 from another computer-readable medium or from another device (e.g., a remote server, an external storage, etc.) via, for example, the communication interface 517. When executed, the computer-executable instructions stored in memory 513 and/or storage component 514 may cause the processor 512 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/ flowcharts disclosed herein is an illustration of example approaches. Based upon design preferences, it is understood that the specific order or hierarchy of blocks in the processes/ flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

1. A vehicle cockpit display for displaying information for a vehicle, the vehicle cockpit display comprising:
at least one processor;
a central partition; and
at least one peripheral partition,
wherein the at least one processor is configured to:
determine a change in vehicle status has occurred; and
based on determining the change in vehicle status has occurred, configuring the at least one peripheral partition to display a video feed from at least one electronic side mirror of the vehicle, wherein the video feed is displayed by including a visual cue comprising a flashing border around the vehicle cockpit display.

2. The vehicle cockpit display as claimed in claim 1, wherein determining the change in vehicle status has occurred is based on receiving a signal from an Electronic Control Unit (ECU) of the vehicle.

3. The vehicle cockpit display as claimed in claim 2, wherein the change in vehicle status comprises at least one of:
a turn light of the vehicle being switched;
a gear position of the vehicle being switched into reverse; and
another vehicle being detected in a blind spot of the vehicle.

4. The vehicle cockpit display as claimed in claim 1, wherein the at least one processor is further configured to display the video feed from the at least one electronic side mirror on the at least one peripheral partition by including an audio cue,
wherein the audio cue comprises a beeping audio cue.

5. The vehicle cockpit display as claimed in claim 1, wherein the central partition comprises an instrument cluster, wherein the instrument cluster comprises a configuration interface for a user to control the video output of displays in the vehicle, including the at least one peripheral partition.

6. The vehicle cockpit display as claimed in claim 5, wherein the instrument cluster comprises a warning message overview interface for indicating which of the displays in the vehicle have a warning message, wherein the user may interact with the warning message overview interface to show details of the warning message.

7. The vehicle cockpit display as claimed in claim 6,
wherein the warning message comprises a priority level including at least one of high priority, medium priority, and low priority,
wherein each warning message of a given priority level is indicated with a unique color, and
wherein the warning message corresponds to a vehicle malfunction.

8. A method for displaying information for a vehicle in a vehicle cockpit display comprising a central partition and at least one peripheral partition, the method comprising:
determining, by the vehicle cockpit display, a change in vehicle status has occurred; and
based on determining the change in vehicle status has occurred, configuring, by the vehicle cockpit display, the at least one peripheral partition to display a video feed from at least one electronic side mirror of the vehicle, wherein the video feed is displayed by including a visual cue comprising a flashing border around the vehicle cockpit display.

9. The method as claimed in claim 8, wherein determining the change in vehicle status has occurred is based on receiving a signal from an Electronic Control Unit (ECU) of the vehicle.

10. The method as claimed in claim 9, wherein the change in vehicle status comprises at least one of:
a turn light of the vehicle being switched;
a gear position of the vehicle being switched into reverse; and
another vehicle being detected in a blind spot of the vehicle.

11. The method as claimed in claim 8, wherein the displaying the video feed further comprises outputting an audio cue,
wherein the audio cue comprises a beeping audio cue.

12. The method as claimed in claim 8, wherein the central partition comprises an instrument cluster, wherein the instrument cluster comprises a configuration interface for a user to control the video output of displays in the vehicle, including the at least one peripheral partition.

13. The method as claimed in claim 12, wherein the instrument cluster comprises a warning message overview interface for indicating which of the displays in the vehicle have a warning message, wherein the user may interact with the warning message overview interface to show details of the warning message.

14. The method as claimed in claim 13,
wherein the warning message comprises a priority level including at least one of high priority, medium priority, and low priority,
wherein each warning message of a given priority level is indicated with a unique color, and
wherein the warning message corresponds to a vehicle malfunction.

15. A non-transitory computer-readable recording medium having recorded thereon instructions to perform a method for a vehicle in a vehicle cockpit display comprising a central partition and at least one peripheral partition, the method comprising:
determining, by the vehicle cockpit display, a change in vehicle status has occurred; and
based on determining the change in vehicle status has occurred, configuring, by the vehicle cockpit display, the at least one peripheral partition to display a video feed from at least one electronic side mirror of the vehicle, wherein the video feed is displayed by including a visual cue comprising a flashing border around the vehicle cockpit display.

16. The non-transitory computer-readable recording medium as claimed in claim 15, wherein determining the change in vehicle status has occurred is based on receiving a signal from an Electronic Control Unit (ECU) of the vehicle.

17. The non-transitory computer-readable recording medium as claimed in claim 16, wherein the change in vehicle status comprises at least one of:
a turn light of the vehicle being switched;
a gear position of the vehicle being switched into reverse; and
another vehicle being detected in a blind spot of the vehicle.

18. (canceled)

19. The non-transitory computer-readable recording medium as claimed in claim 8, wherein the central partition comprises an instrument cluster, wherein the instrument cluster comprises a configuration interface for a user to control the video output of displays in the vehicle, including the at least one peripheral partition.

20. The non-transitory computer-readable recording medium as claimed in claim 19,
wherein the instrument cluster comprises a warning message overview interface for indicating which of the displays in the vehicle have a warning message,
wherein the user may interact with the warning message overview interface to show details of the warning message,
wherein the warning message comprises a priority level including at least one of high priority, medium priority, and low priority,
wherein each warning message of a given priority level is indicated with a unique color, and
wherein the warning message corresponds to a vehicle malfunction.

21. The vehicle cockpit display as claimed in claim 3, wherein the change in vehicle status comprises the gear position of the vehicle being switched into reverse.
